(19) United States
(12) Patent Application Publication
(10) Pub. No.: US 2016/0348042 A1
(43) Pub. Date: Dec. 1, 2016

(54) CONCENTRATED LAUNDRY DETERGENTS

(71) Applicant: Henkel AG & Co. KGaA, Duesseldorf (DE)

(72) Inventors: Peter Schmiedel, Duesseldorf (DE); Kaoru Tachikawa, Urdorf (CH); Yvonne Willemsen, Korschenbroich (DE); Arnd Kessler, Monheim am Rhein (DE); Nicole Bode, Duesseldorf (DE); Iwona Spill, Berlin (DE); Reinhard Strey, Dormagen (DE); Anna Klemmer, Duesseldorf (DE); Christian Nitsch, Duesseldorf (DE)

(73) Assignee: Henkel AG & Co. KGaA, Duesseldorf (DE)

(21) Appl. No.: 15/235,243

(22) Filed: Aug. 12, 2016

Related U.S. Application Data
(63) Continuation of application No. PCT/EP2015/052464, filed on Feb. 6, 2015.

(30) Foreign Application Priority Data
Feb. 19, 2014 (DE) 10 2014 202 990.2

(51) Int. Cl. C11D 17/00; C11D 1/22; D06F 39/04; C11D 1/83; D06F 35/00; D06F 39/02; C11D 11/00; C11D 1/72

(52) U.S. Cl. CPC C11D 17/0021; C11D 11/0017; C11D 17/003; C11D 1/22; C11D 1/72; C11D 1/83; D06F 35/006; D06F 39/02; D06F 39/04

(57) ABSTRACT

One- or multi-phase non-solid concentrated products, which are capable of producing or maintaining a Winsor type 2 microemulsion system upon dilution in a short liquor technology washing machine, show improved performance for fat and oil-containing stains when used in novel methods in which various Winsor types are passed through starting from Winsor type 2.

### FIELD OF THE INVENTION

The present invention generally relates to concentrates, which are suitable for use as laundry detergents in washing machines, to the use thereof for forming microemulsions or a microemulsion system in a washing machine, and to a textile washing method, which is carried out with the formation of a microemulsion or a microemulsion system.

### BACKGROUND OF THE INVENTION

There has been a long-standing need to be able to remove greasy stains effectively. For this reason, the aim of every washing method in general has been to remove the hydrophobic parts of the stains. In order to then effect the taking up of the hydrophobic parts of stains in the wash liquor, a thermodynamically attractive environment must be created for these stains.

The state of the art offers different solutions for this. A method for cleaning and impregnating functional textiles is described in European patent EP 1838915 B1, where the textiles are first wetted with a so-called short liquor, i.e., a liquor that has a ratio of the weight of the amount of dry textile to the weight of the amount of water of greater than 1:8, and then a predefined amount of a hydrophobic active substance is flushed into the tub out of the detergent storage chamber by means of the water and brought into contact with the moistened textiles. According to WO 2010/031675, the processing composition is sprayed out in the form of fine droplets (spray) onto the premoistened wash load.

WO 2005/003268 discloses a washing method in which the detergent is dispersed in a smaller amount of water than in conventional methods and the laundry is thus contacted with a less highly diluted wash liquor at a higher ratio of the amount of dry textile to the amount of water. There are no special requirements for the detergent formulation itself The ratio of the weight of the amount of dry laundry to the weight of the water amount is 1:2 to 4:1.

WO 2013/134168 discloses a washing method in which in at least 2 successive subcycles the laundry is treated with a more concentrated detergent composition in the first subcycle than in a second subcycle. A wash cycle in this case is the time period from the preparation of a wash liquor to the removal of the wash liquor from the washing machine. A wash cycle can be divided into subcycles, whereby the wash liquor is not removed at the end of the first subcycle, but at the beginning of the second cycle new, additional water is added to already existing wash liquor.

It is preferred in this case that the first subcycle lasts longer than the second one. There are no special requirements for the detergent formulation itself.

WO 2012/048911 discloses a washing method in a washing machine, whereby the cleaning agents and optionally different cleaning agents or components thereof are sprayed into the interior of the washing machine. The method and control of the machine are set up so that much less water is consumed in the cleaning and in the rinsing than in conventional methods. There are no further requirements for the cleaning agents with exception of the property that it must be sprayable.

It is known that microemulsions are thermodynamically stable emulsions and have extremely low interfacial tensions. The skilled artisan knows in addition that to loosen dirt the interfacial tension between water and the fatty component of the stain must be reduced.

WO 2013/110682 describes cleaning agents in particular for manual dishwashing, but also for pretreating laundry, whereby the agents contain 1 to 50% by weight of anionic surfactants and 1 to 36% by weight of salts and which form a microemulsion spontaneously upon contact with oils and/or fats. Microemulsions are described, furthermore, which contain 1 to 50% by weight of anionic surfactants, 1 to 36% by weight of salts, 10 to 80% by weight of water, and 10 to 80% by weight of at least one triglyceride or a mixture of a triglyceride and one or more components from the group consisting of waxes, lipids, terpenes, triterpenes, and fatty acids. The microemulsion is formed in situ with the triglycerides or triglyceride-containing mixtures located on the surface to be cleaned.

Acidic cleaning agents for hard surfaces, which can be present in the form of a microemulsion, are known from U.S. Pat. No. 6,121,220. Use of such emulsions in a washing machine is not recommended.

Patent applications EP 0160762 and WO 95/27035 propose oil-in-water microemulsions as detergents.

The German patent application DE 10129517 proposes using microemulsions of water, one or more hydrophobic components, and sugar-based, nonionic surfactants as a stain pretreatment agent for textiles or for the cleaning of hard surfaces. The suitability of these microemulsions for use in washing machines is not described.

Lastly, WO 2011/073062 discloses bicontinuous microemulsion systems, which are suitable as stain pretreatment agents and are capable of dissolving solid and solidified greasy stains in the main wash cycle at a neutral pH.

The object was to provide consumer products which lead to improved removal of greasy and oily stains in particular in improved methods and machines with a lower water consumption.

The subject matter of the present application therefore is a single-phase or multiphase non-solid concentrate for use as a laundry detergent, which is capable of producing or maintaining a Winsor type 2 microemulsion system upon dilution in a washing machine with short-liquor washing technology.

Furthermore, other desirable features and characteristics of the present invention will become apparent from the subsequent detailed description of the invention and the appended claims, taken in conjunction with this background of the invention.

### BRIEF SUMMARY OF THE INVENTION

A single-phase or multiphase non-solid concentrate for use as a laundry detergent, characterized in that the concentrate is capable of producing or maintaining a Winsor type 2 microemulsion system upon dilution in a washing machine with short-liquor washing technology.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

According to Winsor, microemulsion systems, consisting of a water component, an oil component, and an amphiphile, can be divided into 4 types based on their phase equilibriums.

In a Winsor type 1 microemulsion system, the surfactant is soluble primarily in water and in an oil-in-water microemulsion form. It consists of a surfactant-rich aqueous phase (oil-in-water microemulsion) and an excess but surfactant-poor oil phase.

In a Winsor type 2 microemulsion system, the surfactant is soluble primarily in an oil phase and in a water-in-oil microemulsion form. It consists of a surfactant-rich oil phase (water-in-oil microemulsions) and an excess but surfactant-poor aqueous phase.

A Winsor type 3 microemulsion system represents a bicontinuous microemulsion, which is also called a middle-phase microemulsion, of a surfactant-rich middle phase, which coexists with a surfactant-poor aqueous phase and a surfactant-poor oil phase.

A Winsor type 4 microemulsion system, in contrast, is a single-phase homogeneous mixture and represents a microemulsion in contrast to the Winsor types 1 to 3, which consist of 2 or 3 phases of which only one phase is a microemulsion. It usually requires high surfactant concentrations in order to achieve this single-phase state, whereas much lower surfactant concentrations are needed to reach a stable phase equilibrium in Winsor type 1 and type 2 microemulsion systems. For this reason, Winsor type 4 microemulsions are in fact often described in the patent literature, but are used rarely or not at all in domestic machine washing processes. The large surfactant amount needed makes such a process uneconomical and is also, not least, not very environmentally friendly.

The consumer product of the invention represents a single-phase or multiphase concentrate, which is not solid, but at room temperature can be, for example, liquid, gel-like, or pasty. The teaching of the invention takes advantage of the fact that the detergent composition used in the washing machine should be a Winsor type 2 microemulsion system, but the concentrate, which represents the consumer product, need not be already present in the form of a Winsor type 2 microemulsion system. It is sufficient for the purpose of the invention, if the concentrate can be converted to a Winsor type 2 microemulsion system upon dilution with water and in particular in a washing machine with short-liquor washing technology. It can be advantageous, however, if the concentrate as well is already present as a Winsor type 2 microemulsion system. It can also be preferable, if the concentrate is present as a Winsor type 4 microemulsion, if it can be converted to a Winsor type 2 microemulsion system during the preparation of the wash liquor. Because a Winsor type 2 microemulsion system is two-phase, it can be expedient in the interest of a uniform distribution of the short liquor on the washed item that the concentrate from a Winsor type 2 microemulsion system during use is not present macroscopically separated, but the application occurs in such a way that an emulsion of the two phases of the Winsor type 2 system is applied. Such an emulsion can occur, for example, by suitable mixing, particularly stirring of the microemulsion system before application to the washed item.

According to Bancroft, the emulsion type depends on the emulsifier and also on the phase in which the emulsifier, for example, a surfactant or various surfactants, dissolves. If water-soluble, therefore hydrophilic emulsifiers, for example, anionic surfactants, are used, then oil-in-water emulsions form. Anionic surfactants, however, can be made hydrophobic by the addition of salts due to electrostatic shielding of the hydrophilic head group of the anionic surfactants, so that water-in-oil emulsions are achieved. Thus, it is possible by adding salts to carry out a phase inversion and to convert an oil-in-water emulsion with an anionic surfactant as the emulsifier into a water-in-oil emulsion. This can then interact with the greasy and oily dirt and mix with the dirt on the fiber, as a result of which the interfacial tension between the present greasy and oily stains and the water phase is reduced. By diluting the emulsion, the salt concentration is then reduced, the shielding of the ionic head group of the anionic surfactant becomes weaker, and the anionic surfactant is again made hydrophilic as a result. The greasy and oily dirt as a result can be removed better from the textile with the microemulsion and dispersed in the aqueous liquor and finally conveyed away with the aqueous liquor.

The behavior of the emulsifiers is also influenced by the temperature.

If hydrophobic emulsifiers, for example, nonionic surfactants, are employed, then water-in-oil emulsions form. Addition of a salt is not necessary in this case. The nonionic surfactants become hydrophobic due to the higher application temperatures and can interact even better with greasy and oily dirt. If upon dilution of the liquor the temperature is reduced again, thus the nonionic surfactants become hydrophilic again; the greasy and oily dirt can thereby be removed better from the textile, dispersed in the aqueous liquor, and finally be conveyed away with the aqueous liquor.

Thus, phase inversions can be achieved selectively by regulating the temperature and/or addition of salts.

Short-liquor washing technology is understood to be the provision of a first subcycle in which the first contact of the textile or wash load with water and, for example, the flushed- or sprayed-in detergent occurs, whereby the ratio of the weight of the dry textile or wash load to the aqueous liquor is at least 1:8, but preferably a short liquor is used in which the ratio of the weight of the dry textile or wash load to the aqueous liquor is at least 1:4, in particular not less than 1:2, for example, 1:2 to 4:1, advantageously 1:2 to 2:1. According to the invention, the aqueous liquor used in the first subcycle consists of a Winsor type 2 microemulsion system. In preferred embodiments of the invention, the top limit of the weight ratio of the dry textile or wash load to the Winsor type 2 aqueous liquor is limited in that it is to be assured that the entire wash load can be completely soaked during the first subcycle. It is only assured then that the microemulsion can interact with all stains. The bottom limit of the weight ratio of the dry textile or wash load to the Winsor type 2 aqueous liquor in preferred embodiments of the invention is limited in that during use in the washing machine there is as little “free liquor” as possible, therefore as little excess liquor as possible, which cannot be absorbed by the textile or wash load in the first subcycle and remains in the solution sump of the washing machine. A weight ratio of the dry textile or wash load to the Winsor type 2 aqueous liquor of 1:2 to 1:1, in particular not less than 1:1.5, is very particularly preferred for this reason.

The concentrate preferably contains surfactants, which serve as emulsifiers in the Winsor type 2 microemulsion system. The concentrates preferably contain anionic and/or nonionic surfactants, whereby a combination of anionic and nonionic surfactants is especially advantageous in regard to the removal of very different stains. The content in the concentrates of surfactants and in particular of a combination of anionic and nonionic surfactants is preferably 2 to 35% by weight, in particular 5 to 30% by weight.

The Winsor type 2 microemulsion systems used in the short-liquor washing technology typically have at least 0.2% by weight of surfactants, in particular of a combination of anionic and nonionic surfactants. Preferred here are contents of at least 0.3% by weight, preferably of 0.5 to a maximum of 15% by weight, and in particular of 1 to a maximum of 10% by weight of surfactants, in particular of a combination of anionic and nonionic surfactants.

Suitable anionic surfactants comprise alkylbenzenesulfonic acid salts, olefin sulfonic acid salts, C₁₂₋₁₈ alkanesulfonic acid salts, fatty alcohol sulfate, fatty alcohol ether sulfates, but also fatty acid soaps or a mixture of two or more of said anionic surfactants. Of these anionic surfactants, alkylbenzenesulfonic acid salts, fatty alcohol (ether) sulfates, and mixtures thereof are particularly preferred.

Preferably, C₉₋₁₃ alkylbenzene sulfonates, olefin sulfonates, i.e., mixtures of alkene and hydroxyalkane sulfonates, and disulfonates, as are obtained, for example, from C₁₂₋₁₈ monoolefins with a terminal or internal double bond by sulfonation with gaseous sulfur trioxide and subsequent alkaline or acid hydrolysis of the sulfonation products, may be used as sulfonate type surfactants. C₁₂₋₁₈ alkane sulfonates and esters of α-sulfofatty acids (ester sulfonates), for example, the α-sulfonated methyl esters of hydrogenated coconut, palm kernel, or tallow fatty acids, are also suitable.

Preferred as alk(en)yl sulfates are the salts of the sulfuric acid half-esters of C₁₂-C₁₈ fatty alcohols, for example, from coconut fatty alcohol, tallow fatty alcohol, lauryl, myristyl, cetyl, or stearyl alcohol, or C₁₀-C₂₀ oxo alcohols, and the half-esters of secondary alcohols having said chain lengths. C₁₂-C₁₆ alkyl sulfates and C₁₂-C₁₅ alkyl sulfates, as well as C₁₄-C₁₅ alkyl sulfates, are preferred from the washing technology viewpoint. 2,3-Alkyl sulfates are also suitable anionic surfactants.

Also suitable are fatty alcohol ether sulfates, such as the sulfuric acid mono-esters of straight-chain or branched C₇₋₂₁ alcohols, ethoxylated with 1 to 6 mol of ethylene oxide, such as 2-methyl-branched C₉₋₁₁ alcohols with on average 3.5 mol of ethylene oxide (EO) or C₁₂₋₁₈ fatty alcohols with 1 to 4 EO, particularly C₁₂₋₁₄ fatty alcohols with 2 EO.

Other suitable anionic surfactants are fatty acid soaps. Saturated and unsaturated fatty acid soaps, such as the salts of lauric acid, myristic acid, palmitic acid, stearic acid, (hydrogenated) erucic acid, and behenic acid, as well, in particular, soap mixtures derived from natural fatty acids, for example, coconut, palm nut, olive oil, or tallow fatty acids, are suitable. The content of the concentrates of fatty acid soaps is preferably 0 to 5% by weight.

The anionic surfactants including the fatty acid soaps can be present in the form of their sodium, potassium, or magnesium, or ammonium salts. The anionic surfactants are preferably present in the form of their sodium salts and/or ammonium salts. Amines that can be used for neutralization are preferably choline, triethylamine, monoethanolamine, diethanolamine, triethanolamine, methylethylamine, or a mixture thereof, monoethanolamine being preferred.

Suitable nonionic surfactants comprise alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof. Used preferably as alkoxylated fatty alcohols are ethoxylated, particularly primary alcohols having preferably 8 to 18 C atoms and on average 2 to 12 mol of ethylene oxide (EO) per mole of alcohol employed, in which the alcohol moiety is linear. Alcohol ethoxylates having 12 to 18 C atoms, for example, from coconut, palm, tallow fatty, or oleyl alcohol, and on average 5 to 8 EO per mole of alcohol are particularly preferred. The preferred ethoxylated alcohols include, for example, C₁₂₋₁₄ alcohols with 2 EO, 3 EO, 4 EO, or 7 EO, C₉₋₁₁ alcohol with 7 EO, C₁₂₋₁₈ alcohols with 3 EO, 5 EO, or 7 EO, C₁₆₋₁₈ alcohols with 5 EO or 7 EO, and mixtures of these. In addition to these nonionic surfactants, fatty alcohols with more than 12 EO can also be used. Examples of these are tallow fatty alcohol with 14 EO, 25 EO, 30 EO, or 40 EO. It is particularly preferred that a C₁₂₋₁₈ alcohol, in particular a C₁₂-C₁₄ alcohol or a C₁₃ alcohol with on average 2 EO or 3 EO is used as the nonionic surfactant.

Apart from the pure ethylene oxide adducts, however, corresponding propylene oxide adducts, in particular also EO/PO mixed adducts as well, are advantageous with particular preference for C₁₆-C₁₈ alkyl polyglycol ethers each with 2 to 8 EO and PO units. In some embodiments, also EO/BO mixed adducts and even EO/PO/BO mixed adducts are preferred. The particularly preferred EO/PO mixed adducts include C₁₆-C₁₈ fatty alcohols with fewer PO than EO units, in particular C₁₆-C₁₈ fatty alcohols with 4 PO and 6 EO or C₁₆-C₁₈ fatty alcohols with 2 PO and 4 EO.

The indicated degrees of ethoxylation (EO=ethylene oxide; PO=propylene oxide; BO=butylene oxide) are statistical averages, which for a special product can be an integer or a fraction. Preferred alkoxylates have a narrowed homolog distribution.

As already described above, inorganic salts are not absolutely necessary in order to be able to produce Winsor type 2 microemulsions. Nevertheless, concentrates, in particular anionic surfactant-containing concentrates, are preferred which contain one or more inorganic salts. Preferred inorganic salts in this case are alkali metal sulfates and alkali metal halides, in particular chlorides, and alkali metal carbonates. Very particularly preferred inorganic salts are sodium sulfate, sodium hydrogen sulfate, sodium carbonate, sodium hydrogen carbonate, and mixtures thereof. The content in the concentrates of one or more inorganic salts is preferably 20 to 70% by weight.

In the Winsor type 2 microemulsion systems to be prepared, the content of one or more inorganic salts is preferably 2 to 20% by weight and in particular 5 to 15% by weight, whereby the concentrations of 8 to 12% by weight turned out to be particularly preferable.

In preferred embodiments of the invention, the concentrates also contain one or more additive oils. In the context of the present invention, an additive oil, which is used in addition and intentionally for the greasy and oily stains present on the textiles to be washed, is understood in principle to be any organic non-surfactant liquid that is not miscible with water or forms 2 phases in combination with water and itself has grease dissolving power. Such additive oils are preferred in particular, which not only have good grease dissolving power but are also biodegradable and acceptable in terms of odor. Particularly preferred concentrates have as the additive oil dioctyl ether, oleic acid, limonene, low-molecular-weight paraffins, and/or low-molecular-weight silicone oils, for example, also the solvent known from dry cleaning, Cyclosiloxane D5. Aromatic solvents such as toluene are of course also effective additive oils for the purposes stated here; however, they are usually dispensed with for toxicological reasons. The content in the concentrates of one or more additive oils is preferably 2 to 60% by weight and in particular 5 to 50% by weight.

The use of one or more additive oils in the concentrate of the invention has several advantages. First, the additive oils function as solvents for the fats, which are present in solid form at the application temperatures in the washing machine. In addition, the oily and greasy dirt on the laundry is normally not precisely defined. It is therefore not known beforehand which surfactants must be present in the water-in-oil emulsion in order to interact effectively with the dirt such that it is loosened and can be rinsed out of the textile. Another factor is that without the presence of additive oils the greasy and oily dirt on the textiles could bring the microemulsion system out of equilibrium. However, if an additional hydrophobic component as defined above (additive oil) is used at the outset in the concentrate, thus the effect of the greasy and oil dirt on the laundry on the equilibrium of the microemulsion is negligible and the probability of a desired interaction and release of dirt on the textile fiber is increased considerably.

In the Winsor type 2 microemulsion systems to be prepared, the content of one or more additive oils is preferably 0.2 to 20% by weight and in particular 0.5 to 15% by weight, whereby concentrations of 1 to 12% by weight have proven to be particularly preferable.

In particular, Winsor type 2 microemulsion systems, containing 0.2 to 5% by weight of surfactants, advantageously 0.3 to 1% by weight of surfactants, particularly preferably less than 0.1% by weight of surfactants, and 0.5 to 5% by weight, advantageously 1 to 3% by weight of additive oils, can be produced from the concentrates of the invention by dilution with water. With further preference, the aforesaid type Winsor 2 microemulsion systems have 80 to 94.6% by weight of water and 0.2 to 15% by weight of inorganic salts, preferably 1 to 12% by weight of inorganic salts, in particular 5 to 10% by weight inorganic salts.

In further embodiments, it is preferred that the concentrates have inorganic salts and/or additive oils. It has proven especially advantageous in this case, particularly if anionic and nonionic surfactants are present in the concentrates, that the concentrates have both one or more inorganic salts and one or more additive oils. The weight ratio of the inorganic salt to the additive oil can vary over a wide range depending on the employed surfactants. The weight ratios of the inorganic salt/inorganic salts to the additive oil/s of 15:1 to 0.3:1, preferably of 10:1 to 0.5:1, and in particular of 5:1 to 1:1 are advantageous. Particularly preferred additive oils, present in combination with inorganic salts, are diethers. In this case, di-n-octyl ether is used with particular advantage.

In a preferred embodiment of the invention, the concentrate contains sodium sulfate and di-n-octyl ether in the weight ratio of 10:1 to 0.5:1, preferably of 10:1 to 1:1, and in particular of 5:1 to 1:1.

Moreover, the concentrate further can contain at least one, preferably two or more components selected from the following group: builders, bleaching agents, electrolytes, nonaqueous but water-miscible solvents, enzymes, pH adjusting agents, perfumes, perfume carriers, fluorescent agents, dyes, hydrotopes, foam inhibitors, silicone oils, antiredeposition agents, graying inhibitors, sanforizing agents, anticreasing agents, dye transfer inhibitors, antimicrobial substances, germicides, fungicides, antioxidants, preservatives, corrosion inhibitors, antistatic agents, bitter agents, ironing aids, hydrophobizing and impregnating agents, swelling and anti-slip agents, softening components, and UV absorbers.

Silicates, aluminum silicates (especially zeolites), carbonates, salts of organic dicarboxylic and polycarboxylic acids, and mixtures of said substances in particular can be mentioned as builders that may be present in the concentrate.

Organic builders, which may be present in the concentrate, are, for example, the polycarboxylic acids that can be used in the form of their sodium salts, polycarboxylic acids being understood to be carboxylic acids that carry more than one acid function. For example, these are citric acid, adipic acid, succinic acid, glutaric acid, malic acid, tartaric acid, maleic acid, fumaric acid, sugar acids, aminocarboxylic acids, and mixtures thereof. Preferred salts are the salts of polycarboxylic acids, such as citric acid, adipic acid, succinic acid, glutaric acid, tartaric acid, sugar acids, and mixtures thereof.

Further, polymeric polycarboxylates are suitable as builders. These are, for example, the alkali metal salts of polyacrylic acid or polymethacrylic acid, for example, those with a relative molecular mass of 600 to 750,000 g/mol. Suitable polymers are particularly polyacrylates, which preferably have a molecular mass of 1000 to 15,000 g/mol. Because of their superior solubility, from this group in turn the short-chain polyacrylates, which have molar masses of 1000 to 10000 g/mol, and especially preferably of 1000 to 5000 g/mol, can be preferred.

Suitable furthermore are copolymeric polycarboxylates, particularly those of acrylic acid with methacrylic acid and acrylic acid or methacrylic acid with maleic acid. To improve the water solubility, the polymers can also contain allylsulfonic acids, such as allyloxybenzenesulfonic acid and methallylsulfonic acid, as monomer.

Soluble builders such as, for example, citric acid, or acrylic polymers with a molar mass from 1000 to 5000 g/mol are used preferably in the liquid detergents, however.

In addition to the additive oils, nonaqueous, water-miscible solvents can be added to the concentrate. Suitable nonaqueous solvents comprise mono- or polyhydric alcohols, alkanolamines, or glycol ethers. The solvents are selected, for example, from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, and mixtures of said solvents. It must be considered in this case, however, that the type and amount of the nonaqueous but water-miscible solvents must be selected so that a Winsor type 2 microemulsion system can form during the production of the short liquor. Preferred concentrates therefore contain only such organic solvents as the mentioned ethers and diethers, in particular di-n-octyl ether, which can already be used as additive oils. Organic solvents, which are used in conventional liquid detergents and which are miscible with water without forming 2 phases, for example, ethanol, propylene glycol or glycerol, are used, if at all, only in minor amounts, whereby in particularly preferred embodiments such organic solvents miscible with water without the formation of 2 phases are entirely omitted.

In a further embodiment of the invention, anhydrous or at least nearly anhydrous concentrates are used. In the context of the present invention, nearly anhydrous is understood to be that the content of water in the concentrates is no more than 2% by weight, preferably no more than 1% by weight. In a preferred embodiment of the invention, the concentrates are present in the form of an anhydrous paste, which contains surfactants, in particular a mixture of anionic and nonionic surfactants. Advantageously, the surfactant content, in particular the mixture of anionic and nonionic surfactants, in the anhydrous pastes is within the same ranges as in the water-containing concentrates. The same also applies to the other components of the concentrates. Instead of water, the pastes in preferred embodiments can contain in addition finely divided solids, for example, aluminosilicates, such as zeolites or smectites or bentonites, or silicic acids as well, for example, of the Aerosil® type. These finely divided additives do not influence the phase boundaries and the stability of the Winsor type 2 microemulsion systems to be prepared from the pastes.

The concentrates of the invention can be produced by any method known from the state of the art.

It is preferred in addition to provide the concentrates of the invention in the form of individual portions. These include in particular containers made of water-soluble materials, which are filled with the concentrates of the invention. Particularly preferred are single-chamber or multi-chamber containers, primarily made of polyvinyl alcohol or polyvinyl alcohol derivatives or copolymers with vinyl alcohol or vinyl alcohol derivatives as monomer. These single portions assure that the amount of the concentrate of the invention, said amount which is appropriate for producing the Winsor type 2 microemulsion system and for the corresponding performance associated therewith, is used in the first subcycle. Optionally, a plurality of single portions can also be used depending on the amount of the textile or wash load to be washed.

A further embodiment of the invention provides that the concentrates are present in a form granulated onto a carrier. Carrier materials known for detergents from the state of the art may be used as carrier materials. Particularly preferred are detergent ingredients such as builders and alkali donors, for example, alkali carbonates or zeolites, or bleaching agents such as percarbonates or enzyme granules, but sodium sulfates or silicates as well, and in particular substances that have a high absorption capacity for liquids, for example, silicic acid. Such granulated products, moreover, can be powdered with finely divided materials, which are known for this purpose from the state of the art. Particularly preferred are silicic acid, zeolites, or other aluminosilicates, but mixtures of silicic acids and zeolites as well.

A further subject matter of the invention is the use of a concentrate as described above for forming a short liquor of a Winsor type 2 microemulsion system. All facts and embodiments, described for the concentrates, are also valid for the use.

A further subject matter of the invention is a textile washing method in a washing machine, in particular in a domestic washing machine, with a wash cycle with at least two successive subcycles, whereby
the wash load to be cleaned is placed in the laundry treatment chamber of the washing machine,
a concentrate as described above or a granulated concentrate as described above is added to a detergent storage chamber of the washing machine, and
is conveyed, preferably sprayed in or pumped in, in the first subcycle with the simultaneous formation of a short liquor in the laundry treatment chamber of the washing machine, whereby a Winsor type 2 microemulsion system is formed or maintained as the short liquor,
an interaction of the Winsor type 2 short liquor with the dirt on the wash load occurs in the first subcycle, as a result of which the interfacial tension between the present greasy and oily stains and the water phase is reduced,
next, in at least one further subcycle the liquor is diluted with water and is diluted further with water until a long liquor forms,
in this case, the dirt is loosened from the wash load, and
at the end of the last subcycle the dirt together with the long liquor is conveyed out of the laundry treatment chamber.

The method provides that a wash cycle is carried out with at least 2 successive subcycles. A wash cycle in this case is the time period from the formation of a first detergent-containing wash liquor to the removal of the wash liquor from the washing machine. The wash cycle is divided into at least two subcycles, whereby the wash liquor is not removed at the end of the first to the next-to-last subcycle. In the preferred embodiment, which provides for a wash cycle with 2 successive subcycles, the short liquor is formed in the form of a Winsor type 2 microemulsion system at the beginning of the first subcycle or maintained if the employed concentrate was already present as a Winsor type 2 microemulsion system, whereas at the beginning of the second subcycle, new, additional water is added to the already existing wash liquor to form a long liquor.

A method of this type is preferably carried out in a washing machine, in particular in a domestic washing machine, which enables a short-liquor washing technology. The statements made above apply accordingly in regard to the short-liquor washing technology and to the short liquor. The machines in question allow the use of concentrates or granulated concentrates to produce a short liquor in the machine.

Because a Winsor type 2 microemulsion system is biphasic, a method is preferred, which in the interest of a uniform distribution of the short liquor on the wash load provides that the Winsor type 2 microemulsion system is not present macroscopically separated during the application, but is introduced as an emulsion of the two phases into the laundry treatment chamber and applied to the wash load. This temporary emulsion can be formed, for example, by vigorous mixing, in particular by stirring.

The machine measures the weight of the dry textile or wash load and adds the amount of water required to form the short liquor. This is combined with concentrates of the invention in the aforesaid mixing device with the formation of a Winsor type 2 microemulsion system. In order to be able to produce a temporary emulsion of the Winsor type 2 microemulsion system which is biphasic in itself, it can be preferable that the machine provides a chamber in which a temporary emulsion of the concentrate and the supplied water can be formed. This can be supported by providing a mixing device, preferably a stirring device in this mixing chamber. In this regard, in the case of the mixing chamber for producing a temporary emulsion, this can be the rinsing chamber of a washing machine, in particular a domestic washing machine, but also an additional chamber in the machine, in particular the domestic washing machine.

It is preferred, furthermore, that after the wash load weight determination, the machine displays the weight in a readable form for the user, so that the user can meter in the appropriate amount of the concentrate. Depending on the wash load weight, the appropriate metering amounts of the concentrate, necessary to form the Winsor type 2 microemulsion system, can be read by the user on the outer package of the concentrate and/or in an appropriately programmable machine indicated by the machine itself.

Because a free wash liquor, therefore liquor, which cannot be absorbed by the wash load and remains in the solution sump of the machine, would result in an unnecessary dilution of the system and optionally even worsening of the washing result, the method of the invention provides that as little free liquor as possible forms. It has proven advantageous, if a ratio of the weight of the dry textile or wash load to the short liquor of at least 1:8, preferably of at least 1:4, in particular of not less than 1:2, for example, of 1:2 to 4:1, is formed in the first subcycle. It is preferred in particular, if a ratio of the weight of the dry textile or wash load to the short liquor of not less than 1:1.5 is formed in the first subcycle. In a particular method, this ratio can be 1:1.2 to 1.2:1, ideally also 1:1.

The uniform distribution of the short liquor on the wash load occurs in the washing machine, in particular a domestic washing machine, preferably by an injection, spraying, or recirculating system, for example, a recirculating pump.

In a preferred embodiment of the invention, a method is proposed, which provides a ratio of the weight of the dry textile or wash load to the short liquor of 1:2 to 1:1.5, whereby the distribution of the short liquor occurs by means of a recirculating pump.

The wash liquor is not removed at the end of the first subcycle. Additional water is supplied at the start of the second subcycle, which finally leads to the formation of a liquor, as is known from conventional washing methods. This most diluted liquor is called a long liquor in the context of the present invention to better differentiate it from the short liquor. The liquor, which comprises the dilution steps of the short liquor up to the long liquor, is called the dilution liquor in the context of the present invention. The concentration of the detergent in the liquor is reduced during the dilution of the short liquor up to the formation of the long liquor. Moreover, in a preferred embodiment the hydrophilicity and water solubility of a preferably present nonionic surfactant is increased by diluting the concentration of the preferred present salt. A phase inversion is caused by this, whereby first a Winsor type 3 microemulsion system and lastly with further dilution a Winsor type 1 microemulsion system are formed. Without wishing to be restricted to this theory, the applicant assumes that the formation of the Winsor type 3 microemulsion systems is responsible for the improved release of the dirt loosened by the Winsor type 2 microemulsion system. The skilled artisan knows that the interfacial tension in the three-phase region of the Winsor type 3 microemulsion system is very low. It is also known that low interfacial tensions promote the release of fat. A further advantage of the low interfacial tensions of the Winsor type 3 microemulsion systems is that due to the better grease dissolving power less surfactant can be used than in conventional Winsor type 4 microemulsions, as a result of which the method can be made more economical and more environmentally friendly.

Only the interaction of the Winsor type 2 microemulsion system in the short liquor in the first subcycle and the Winsor type 3 and Winsor type 1 microemulsion systems in the second subcycle or the other subcycles then leads to the especially good washing results.

As already stated, the second subcycle is started by the supplying of water, as a result of which the short liquor is diluted. If the addition of the rest of the water to the final dilution and thereby the formation of the long liquor occur without a further temporary interruption, thus the phase inversion occurs via the Winsor type 3 microemulsion system up to the Winsor type 1 microemulsion system in the second subcycle.

It can be of advantage, however, if the dilution of the short liquor to the long liquor occurs in individual steps, therefore with the water addition being interrupted. In a particularly preferred embodiment of the invention, therefore a textile washing method as described above is carried out in which the phase inversion occurs during the second subcycle or during the other subcycles, whereby first a Winsor type 3 microemulsion system and lastly a Winsor type 1 system are formed. Preferred in particular is a method, which is characterized by running through at least 3 subcycles, whereby the second subcycle comprises the production of a Winsor type 3 microemulsion system as the dilution liquor and the third subcycle comprises the washing method with the long liquor, therefore the final amount of the supplied water, optionally for the conveying away of the long liquor. The second subcycle can comprise a number of steps, which represent different dilution steps, whereby however there is a Winsor type 3 microemulsion system in all steps. As soon as the dilution has progressed so far that the phase inversion to the Winsor type 1 occurs, the third subcycle begins. Another addition of water in this third subcycle is naturally possible, but is not necessary either for reasons of performance or desirable for ecological or economic reasons and therefore not preferable.

In a further preferred embodiment of the method, the heating of the machine is turned on in the first subcycle and only in the first subcycle, whereas the heating is turned off in the second subcycle and, if present, other subcycles and in optionally subsequent rinse cycles. This has advantages especially if the Winsor type 2 microemulsion system contains nonionic surfactants in the short liquor. Nonionic surfactants become hydrophobic with an increasing temperature and hydrophilic with a decreasing temperature. The heated nonionic surfactants produce a higher hydrophobicity of the short liquor, as a result of which the interaction with greasy and oily dirt and its release on the textiles is improved, whereas the nonionic surfactants in the cooling dilution liquor and the colder long liquor become hydrophilic and rinse out better with the water together with the dirt and can be conveyed away.

In a preferred embodiment of the method, it is provided for this reason that the first subcycle is carried out at temperatures of 10 to 60° C., preferably of at least 20 to 40° C.

In addition, the method has the advantage that the energy for heating is consumed only in the first subcycle in contrast to conventional methods. Because the first subcycle includes only a short liquor, in contrast to conventional methods in which a long liquor, therefore a higher amount of aqueous liquor must be heated, energy is saved as a result.

Lastly, the dirt together with the long liquor is conveyed away optionally after other subcycles are run and removed from the laundry treatment chamber of the washing machine.

In further washing, cleaning, or care cycles, a nonaqueous liquor can be provided, whereby in the context of the present invention less than 10% by weight of water, based on the liquor, is supplied to produce nonaqueous liquor. In these further washing, cleaning, or care cycles, other cleaning steps or care steps, for example, impregnation of textiles against water and/or dirt, can be carried out. This further washing, cleaning, or care step or the other steps can take place depending on their purpose before and/or after the rinse cycles.

### EXAMPLES

### Example 1

### Washing Performance

The following stains were tested:
colored olive oil
colored lard
pigment/lanolin
pigment/sebum.

To prepare the native stains, olive oil and lard, WFK 10A cotton swatches were stained with 0.3 mL of olive oil or lard. Commercially obtainable stained test fabrics made of 50:50 polyester/cotton were selected for the two other stains.

The washing tests were carried out in a Launder-Ometer® (ATLAS Textile Test Products) with a 60-minute wash program at 40° C. For this purpose, 2 cotton swatches (olive oil and lard), or in another test 2 stained test fabrics made of 50/50 polyester/cotton together with 10 ballast swatches WFK 10A (each 2.2 g) and 10 steel balls in each case were added. The amount of dry textile (sum of stained swatches and ballast swatches) therefore was 26.6 g.

The concentrates K1 to K5 (Table 1) were prepared and converted to Winsor type 2 microemulsions (M1 to M5) by mixing with water. The cotton swatches/test fabrics and the ballast swatches were sprayed by a trigger pump until 100% moistening of the textiles is achieved (the weight ratio of the dry test fabrics to the Winsor type 2 microemulsion system was 1:1).

The wash program was then started with the formation of a long liquor. The wash cycle was followed by 3 rinse cycles of 10 minutes each at 20° C. After the wash cycle and after each rinse cycle, the liquors were poured off and the swatches were squeezed out briefly. The amount of 200 mL of water was added to each rinse cycle. After drying by hanging and pressing of the material swatches/test fabrics, the whiteness thereof was determined by spectrophotometry.

1. Comparison Test

The test of the invention was repeated with a commercial premium heavy-duty detergent (liquid detergent). To this end, a concentrate of 30.15 g of the premium heavy-duty detergent was dissolved/emulsified in a liter of water (V1). V1 was sprayed onto the test fabrics until 100% moistening was achieved, so that the weight ratio of the dry test fabrics to V1 was 1:1 as in the test of the invention. Therefore, 0.8 g of the premium heavy-duty detergent was used in this test.

2. Comparison Test (Standard)

A liquor of 4.07 g/L of the same premium heavy-duty detergent as in the first comparison test was prepared and a liquor of 200 mL was provided in the wash cycle. Therefore, the amount of the premium heavy-duty detergent used was 0.8 g as in the first comparison test.

The tests were repeated twice. The results listed in Table 2 are averages of 3 swatches/test fabrics each, with 6 measurements in each case.

TABLE 1
Concentrates K1/M1 to K5/M5 (quantitative data given
in % by weight)

| Composition | K1/M1 | K2/M2 | K3/M3 | K4/M4 | K5/M5 |
|---|---|---|---|---|---|
| C10-C13 alkylbenzene | 8/2 | 12/3 | 11/1.8 | 13.8/4.6 | 5.7/1.38 |
| sulfonate, Na salt | | | | | |
| Marlox ® RT | 8/2 | 16/4 | 16/2.7 | 16/5.33 | 6.4/1.6 |
| 64 (C₁₆-C₁₈ | | | | | |
| polyalkylene | | | | | |
| glycol ether; | | | | | |
| producer: Sasol) | | | | | |
| Di-n-octyl ether | 40/10 | 20/5 | 6/1 | 30/10 | 40/10 |
| Sodium sulfate | 40/10 | 40/10 | 60/10 | 30/10 | 40/10 |
| Water | To 100 | To 100 | To 100 | To 100 | To 100 |

TABLE 2
Whiteness (differences dY)

| Stain | V1 | V2 | K1/M1 | K2/M2 | K3/M3 | K4/M4 | K5/M5 |
|---|---|---|---|---|---|---|---|
| Olive oil | 26.39 | 27.74 | 34.94 | 34.31 | 30.84 | 38.46 | 34.73 |
| Lard | 19.91 | 35.44 | 48.34 | 46.48 | 42.13 | 48.02 | 45.07 |
| Pigment/ | 8.42 | 7.48 | 39.32 | 39.50 | 33.47 | 39.84 | 36.02 |
| lanolin | | | | | | | |
| Pigment/ | 20.98 | 26.22 | 32.53 | 37.61 | 39.35 | 41.19 | 31.88 |
| sebum | | | | | | | |

The concentrates of the invention and the Winsor type 2 microemulsion systems prepared from them exhibit significantly better performances both relative to a conventional washing method with a commercial liquid premium heavy-duty detergent and also relative to the new method with the commercial liquid premium heavy-duty detergent. It must also be recognized here that conventional liquid premium heavy-duty detergents have considerably poorer performances in part in the new method (V1) than in standard washing processes (V2).

### Example 2

Anhydrous concentrates (pastes) and the Winsor type 2 microemulsion systems prepared therefrom are listed in Table 3.

TABLE 3
(quantitative data given in % by weight)

| Composition | K6/M6 | K7/M7 | K8/M8 | K9/M9 | K10/M10 |
|---|---|---|---|---|---|
| C10-C13 | 8/2 | 12/3 | 11/1.8 | 13.8/4.6 | 5.7/1.38 |
| alkylbenzene | | | | | |
| sulfonate, Na salt | | | | | |
| Marlox ® RT 64 | 8/2 | 16/4 | 16/2.7 | 16/5.33 | 6.4/1.6 |
| (C16-C18 | | | | | |
| polyalkylene glycol | | | | | |
| ether; producer: | | | | | |
| Sasol) | | | | | |
| Di-n-octyl ether | 40/10 | 20/5 | 6/1 | 30/10 | 40/10 |
| Sodium sulfate | 40/10 | 40/10 | 60/10 | 30/10 | 40/10 |
| Aerosil ® R816 | To 100 | To 100 | To 100 | To 100 | To 100 |

Finely divided aluminosilicates, primarily zeolites, can also be used as a substitute for Aerosil. Both do not affect the phase boundaries.

### Example 3

Table 4 shows a further example of the composition of a short liquor in the form of a Winsor type 2 microemulsion system (M11) with a surfactant content of less than 1% by weight.

TABLE 4
(quantitative data given in % by weight)

| Composition | M11 |
|---|---|
| C10-C13 alkylbenzene | 0.43 |
| sulfonate, Na salt | |
| Marlox ® RT 42 (C16-C18 | 0.41 |
| polyalkylene glycol ether; | |
| producer: Sasol) | |
| Di-n-octyl ether | 1.98 |
| Sodium sulfate | 9.72 |
| Water | To 100 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A single-phase or multiphase non-solid concentrate for use as a laundry detergent, characterized in that the concentrate is capable of producing or maintaining a Winsor type 2 microemulsion system upon dilution in a washing machine with short-liquor washing technology.

2. The concentrate according to claim 1, characterized in that it comprises a combination of anionic and nonionic surfactants in amounts of 2 to 35% by weight.

3. The concentrate according to claim 2, characterized in that it comprises one or more inorganic salts in amounts of 20 to 70% by weight.

4. The concentrate according to claim 3, characterized in that it comprises one or more additive oils in amounts of 2 to 60% by weight.

5. The concentrate according to claim 1, characterized in that it comprises one or more inorganic salts, and one or more diethers.

6. The concentrate according to claim 1, characterized in that it is present as an anhydrous paste and contains a mixture of anionic and nonionic surfactants.

7. The concentrate according to claim 1, characterized in that it can be converted by dilution with water to a Winsor type 2 microemulsion system, that comprises 0.2 to 5% by weight of surfactants and 0.5 to 5% by weight of additive oils, and 80 to 94.6% by weight of water and 0.2 to 15% by weight of inorganic salts.

8. An agent, characterized in that a concentrate according to claim 1 is present in a form granulated onto a carrier.

9. A textile washing method in a washing machine with a wash cycle with at least two successive subcycles, characterized in that the wash load to be cleaned is placed in the laundry treatment chamber of the washing machine, a concentrate according to claim 1 is added to a detergent storage chamber of the washing machine, and in the first subcycle during simultaneous formation of a short liquor is conveyed into the laundry treatment chamber of the washing machine, whereby a Winsor type 2 microemulsion system is produced or maintained as the short liquor, an interaction of the Winsor type 2 short liquor with the dirt present in the wash load occurs in the first subcycle, as a result of which a release of the greasy and oily dirt on the fiber is effected, next in at least one further subcycle the liquor is diluted with water and is diluted further with water until a long liquor forms, whereby the dirt is loosened from the wash load, and at the end of the last subcycle the dirt together with the long liquor is conveyed out of the laundry treatment chamber.

10. The textile washing method according to claim 9, characterized in that the Winsor type 2 microemulsion system is not present macroscopically separated during the application, but is introduced as an emulsion of the two phases of the Winsor type 2 microemulsion system into the laundry treatment chamber of the machine and is applied to the wash load.

11. The textile washing method according to claim 9, characterized in that in the first subcycle a ratio of the weight of the dry textile or wash load to the short liquor of not less than 1:2 is formed.

12. The textile washing method according to claim 9, characterized in that a phase inversion occurs during the subcycle following the first subcycle or the further subcycles following the first subcycle, whereby first a Winsor type 3 and lastly a Winsor type 1 microemulsion system is formed.

13. The textile washing method according to claim 9, characterized in that at least 3 subcycles are run, whereby the second subcycle comprises the production of a Winsor type 3 microemulsion system as a dilution liquor and the third subcycle comprises the washing method with the long liquor.

14. The textile washing method according to claim 9, characterized in that the heating of the washing machine is turned on in the first subcycle, whereas the heating is turned off in the second subcycle and, if present, other subcycles and in optionally subsequent rinse cycles.
